(19) United States
(12) Patent Application Publication
(10) Pub. No.: US 2016/0171174 A1
(43) Pub. Date: Jun. 16, 2016

(54) SYSTEM AND METHODS FOR MANAGING CONGESTIVE HEART FAILURE

(71) Applicant: STC.UNM, Albuquerque, NM (US)

(72) Inventor: Glen H. Murata, Albuquerque, NM (US)

(73) Assignee: STC.UNM, Albuquerque, NM (US)

(21) Appl. No.: 14/907,426

(22) PCT Filed: Aug. 15, 2014
(86) PCT No.: PCT/US2014/051322

§ 371 Date: Jan. 25, 2016

Related U.S. Application Data
(60) Provisional application No. 61/866,199, filed on Aug. 15, 2013.

(51) Int. Cl. G06F 19/00; G06F 17/30

(52) U.S. Cl. CPC G06F 19/3443; G06F 17/30592

(57) ABSTRACT

The invention is a multi-purpose system and methods that focuses on the prevention of congestive heart failure (CHF) exacerbations by identifying the population at risk, examining their use of medications that optimize ventricular function, tracking weight changes through different phases of illness, and retrieving vital sign and laboratory data needed for treatment intensification.

### CROSS-REFERENCE TO RELATED APPLICATIONS

This application claims priority to U.S. Provisional Patent Application No. 61/866,199 filed Aug. 15, 2013.

### FIELD OF THE INVENTION

The invention relates generally to health care including health care system and methods. More specifically, the invention relates to a system and methods for identifying patient variables related to a diagnosis such as congestive heart failure (CHF) for evaluation such as to predict hospital re-admission. The invention quantifies the contribution of each cause of the diagnosis and identifies patients with each cause. Quantification of the contribution of each cause may also be used to create standards for institutional performance as well as support the triage patients by assigning appropriate health care providers.

### BACKGROUND

Although the invention is described with respect to congestive heart failure (CHF), any disease or diagnosis is contemplated, for example, a cerebrovascular accident (CVA). Congestive heart failure is one of the most common reasons for admission to the hospital. It is estimated that over one million Americans are hospitalized every year with a primary diagnosis of CHF with three-fourths of the cases occurring in patients 65 years of age or older. In 2008, this problem accounted for $17 billion in health care costs for Medicare alone.

Some cases of decompensated CHF are precipitated by an abrupt deterioration in left ventricular (LV) function associated with an acute cardiac event such as a myocardial infarction. However, most cases can be attributed to progressive volume overload caused by chronic systolic dysfunction. Most of the latter cases are treated with salt and water restriction and intravenous diuretics. Patients are then discharged from the hospital to continue their treatment at home. The strategy presumes that patients can sustain the initial diuresis by monitoring their weights and using oral diuretics. Unfortunately, this assumption is not warranted in a large proportion of cases. In 2007, the Medicare Payment Advisory Commission reported that 24.8% of CHF patients were readmitted within 30 days of an index hospitalization in 2005. The rates vary widely across facilities and approached 50% at 6 months for many. This problem has become so pervasive that re-admission for CHF has become a national standard for the quality of care.

In 2010, the Affordable Care Act required Medicare to adopt a program to reduce 30-day, all-cause re-admission rates for 3 conditions—(1) acute myocardial infarction, (2) pneumonia, and (3) CHF. The primary incentive is a financial penalty levied against hospitals with re-admission rates considered to be excessive with the United States Center for Medicare and Medicaid Services (CMS) imposing a penalty on total Medicare revenue for hospitals with re-admission rates considered excessive.

To make this determination, CMS calculated expected rates for these conditions from July 2008 to June 2011 with adjustments for age, gender, and co-morbidities such as diabetes and hypertension. Expected rates are compared to actual rates and penalties assessed against hospitals where the latter exceed the former. With the imposition of penalties, CMS expects to recoup $280 million from more than 2,200 hospitals (⅔ of participants) in 2013 alone. Thus far, the proportion of hospitals penalized far exceeds the 5% that was projected before the start of the program.

Criticism of this policy has typically focused on two areas. First, the factors that drive re-admission rates often occur outside of the hospital. Examples include inadequate use of outpatient medications or patient non-adherence. Opponents argue that it is inappropriate to penalize institutions for circumstances over which they have no control. Second, the assessment ignores overwhelming evidence that two groups are at high risk—those with more severe illness and those who are socio-economically disadvantaged. The former have less cardiac reserve and are much more vulnerable to small fluctuations in cardiac function. The effect of low socio-economic status may be mediated by low health literacy, limited resources for health care, and lack of access to primary care. Unless the method for calculating expected rates is adjusted, the program disproportionately penalizes institutions that care for the most socially and clinically vulnerable patients. Even worse, these facilities have the smallest operating margins and fewest opportunities to recoup losses from other sources of revenue.

Due to its impact on patient well-being and extraordinary cost, this problem has been examined extensively with a large number of studies attempting to identify risk factors for re-admission. Some studies examined the association between these factors and outcomes, while others developed formal prediction rules. Some studies chose all-cause re-admission as the outcome and others used CHF-specific re-admission, while still others combined re-admission and death into a composite end-point. However, none compared re-admission rates across hospitals. Predictor variables included socio-demographic factors, co-morbidities, LV ejection fraction, symptom severity and biomarkers such as BUN, creatinine, brain natriuretic peptide (BNP), and troponin. BNP is the brain variant of a peptide released by cardiac atria in response to distention—ordinarily a consequence of volume overload. The action is to promote sodium loss in the urine. Few patient characteristics were consistently associated with re-admission rates. Certain prediction models relied on retrospective administrative data, while others used administrative data to identify high-risk patients in real time, and yet others incorporated primary data collection—although some of the latter retrieved variables unlikely to be available while the patient was hospitalized. One strategy for modeling an outcome is known as a prediction model that identifies patients at high risk for the event. It may be comprised of causal or non-causal factors, but the selection is limited to those available at the time of the assessment. For example, a prescribed dose of medication can be used to predict blood pressure (BP) response but not adherence, which is assessed in retrospect. Knowledge of the underlying biologic processes is not required. Because the association between predictors and outcome is statistical, the model may not be stable across populations where demographics or disease markers may vary. Thus, a model that uses age as a predictor in a geriatric population fails when applied to children with congenital heart disease. The main reason for predictive modeling is to identify patients for intensified observation and prevention. Unfortunately, this strategy usually does not provide insight into what interventions might be effective. As a result, they do not provide information about initial severity or whether the objectives for admission were ever achieved.

Another strategy known as explanatory modeling attempts to validate a causal factor or test competing theories of causality. The candidate variables are restricted to those with a plausible mechanism of injury. Information about those mechanisms may be obtained prospectively or retrospectively, but the analytical approach should conform to the standards of hypothesis testing—including a well-crafted hypothesis, appropriate statistical method, adequate power, and avoidance of exploratory procedures such as “stepping”. Markers should not be included except to evaluate the possibility of causal factors other than the ones that are known. For example, patient age is a reasonable candidate for a prediction model but should be avoided in an explanatory model containing age-dependent mechanisms of injury. The reason is that, as a composite variable, age may replace the underlying causal factors—leading to the conclusion that advanced age carries a poor prognosis and that there is nothing treatable. However, it is reasonable to step this variable into the model after the causal factors have been entered to see if there is a residual effect of age. Thus, a well-developed explanatory model could provide information about interventions that might prevent or reverse the outcome. Moreover, because the predictors and outcomes are related through cause and effect, the association should be durable no matter what population is studied. Finally, unlike a prediction rule, the “fit” of a composite model is not relevant. For example, a treatment can be highly effective even though it does not discriminate well between persons with favorable or poor outcomes.

With the exception of the model related to BNP, none of these CHF models tested theories of causality, assessed the indications for admission, or evaluated the response to therapy. As a result, they provide no insight into how to prevent hospital re-admission rates with respect to CHF. The invention satisfies this need.

### SUMMARY OF THE INVENTION

The invention identifies and evaluates of patient variables with respect to congestive heart failure (CHF) to elucidate the mechanisms for hospital re-admission rates. The invention quantifies the contribution of each cause of CHF and identifies patients with each cause. Quantification of the contribution of each cause may also be used to create standards for institutional performance as well as support the triage patients by assigning appropriate health care providers.

More specifically, the evaluation of CHF re-admission rates based upon explanatory modeling of well-grounded theories of causality is proposed with each of the causal factors capable of being reversed by a validated intervention. The invention is based upon the premise that treatment failure can occur in any one of five phases in the pathogenesis of relapse: baseline function, early decompensation, presentation, in-hospital diuresis, and post-hospital care.

The invention identifies all patients with CHF, gathers information from their electronic medical records, synthesizes novel variables from raw data, and creates a profile for each patient describing his/her prior hospitalizations and current treatment. The baseline metrics include the prescribed dose of and adherence to five classes of medications that stabilize ventricular function.

According to one embodiment of the invention, patient variables are identified and evaluated related to a diagnosis such as congestive heart failure, the computer system including a processor configured to execute the steps comprising of accessing a data warehouse to retrieve data relating to one or more patients of a patient population. A database of patient records is obtained with each patient record corresponding to a patient of the patient population. The processor sorts the one or more patient records according to a diagnosis such as CHF to obtain a set of diagnosed patient records. It is also contemplated that the diagnosis may be classified according to the International Classification of Diseases. One or more patient variables are obtained by the processor from the data warehouse and the one or more patient variables are joined by the processor to each diagnosed patient record. Patient variables are any data that may be retrieved from the data warehouse including, for example, an admission date and a discharge date of each hospitalization, weight measurements, laboratory results, vital signs, and drug treatments classes, to name a few. Based on the one or more patient variables, the processor provides a patient profile for each diagnosed patient record of the set. One or more patient profiles are identified that match a failure mode. The failure mode is assigned by the processor to each patient profile and a solution is provided for the failure mode.

The invention incorporates competing theories of causality to assign each patient to one or more failure modes. A solution or intervention is available for each failure mode: a) a monitored prevention program for patients inadequately treated with drugs at baseline such as by using heart failure drugs; b) diuretic self-titration such as for those gaining excessive weight; c) a changed protocol on hospital admission including, for example, evaluation of central hemodynamics for those presenting with high BNP; d) , individualized discharge criterion for those with inadequate in-hospital diuresis; and e) supervised post-hospital care such as for those with a positive weight trajectory after discharge. The invention may be used to analyze the performance of health care systems with unprecedented detail and identifies patient-specific interventions to optimize their outcomes. The invention may be valuable to any facility interested in improving patient well-being, lowering costs, and avoiding penalties associated with under-performance.

### BRIEF DESCRIPTION OF THE DRAWINGS

FIG. 1 illustrates a block diagram of software framework according to one embodiment of the invention.

FIG. 2 illustrates a block diagram of metrics for predicting a re-admission rate according to one embodiment of the invention.

FIG. 3 illustrates a block diagram of modules for predicting a re-admission rate according to one embodiment of the invention.

FIG. 4 illustrates a table of prescriptions organized into courses according to one embodiment of the invention.

FIG. 5 illustrates a table of prescriptions organized into courses according to one embodiment of the invention.

FIG. 6 illustrates a table of prescriptions organized into courses according to one embodiment of the invention.

FIG. 7 illustrates an exemplary computer system that may be used to implement the programs according to the invention.

### DETAILED DESCRIPTION OF THE INVENTION

The invention is directed to the management of a diagnosis such as congestive heart failure (CHF) by incorporating competing theories of causality and assigning each patient to one or more failure modes. It analyzes the performance of health care systems with unprecedented detail and identifies patient-specific interventions to optimize their outcomes. It is valuable to any facility interested in improving patient well-being, lowering costs, and avoiding penalties associated with under-performance.

The invention is based upon the premise that treatment failure can occur in any one of five phases in the pathogenesis of relapse. It identifies all patients with CHF; gathers information from their electronic medical records; synthesizes novel variables from raw data; and creates a profile for each patient describing his/her prior hospitalizations and current treatment. The baseline metrics include the prescribed dose of and adherence to five classes of medications that stabilize ventricular function. The early CHF variables include average pre-hospital weight gain and fractional increase over dry weight. The in-hospital variables include weight loss and fractional loss of the excess weight. The post-hospital variable consists of a weight trajectory.

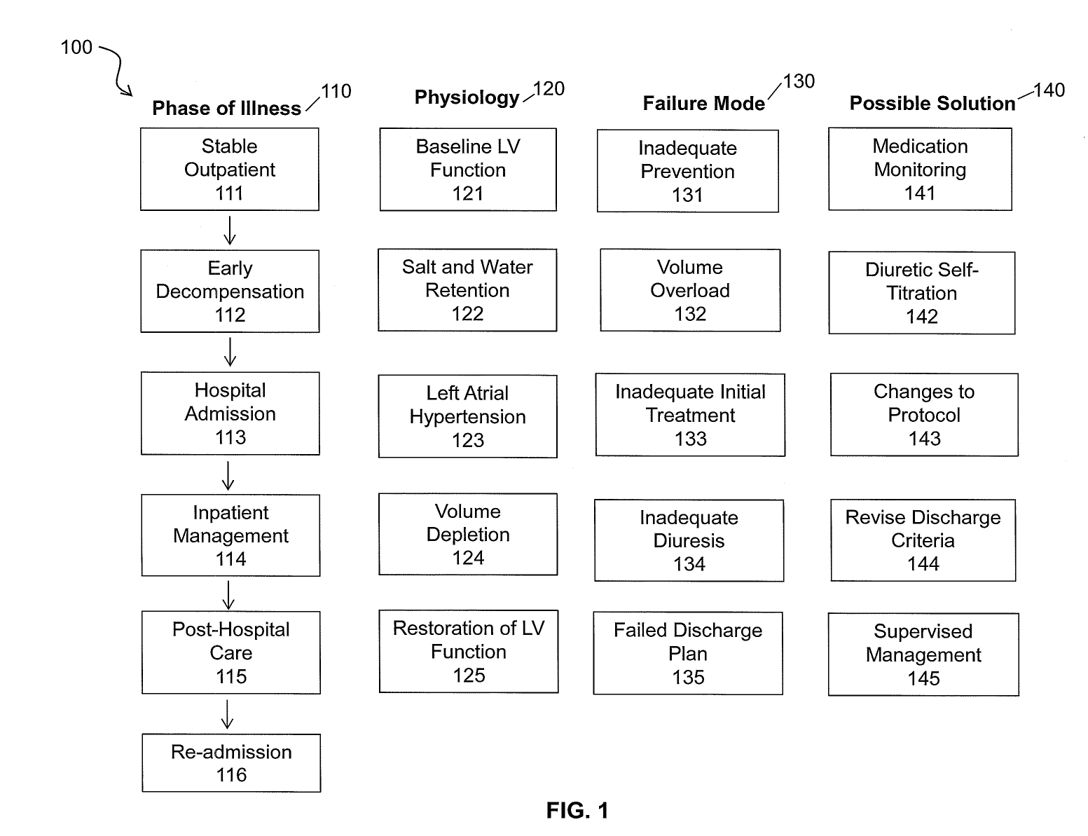

FIG. 1 illustrates a block diagram of software framework 100 according to one embodiment of the invention. A failure mode 130 corresponds to each of phases of illness 110 based upon the associated pathophysiology 120. Each failure mode 130 includes a possible solution 140. More specifically, column 110 presents five phases in the natural history of decompensation. Column 120 describes the associated biologic processes that determine the patient's clinical status. Column 130 shows how each process might contribute to a poor prognosis, while column 140 shows how that outcome might be averted.

An outcome may be averted by an intervention or a solution 140 available for each failure mode 130. Possible solutions 140 include a monitored prevention program for patients inadequately treated with drugs at baseline 141, diuretic self-titration for those gaining excessive weight 142, evaluation of central hemodynamics for those presenting with high brain natriuretic peptide (BNP) 143, revised discharge criteria for those with inadequate in-hospital diuresis 144, and supervised post-hospital care for those with a positive weight trajectory 145.

The five phases of illness shown in column 110 include stable outpatient 111, early decompensation 112, hospital admission 113, inpatient management 114, and post-hospital care 115. The phases of illness as shown in 110 may lead to re-admission 116, which is predicted by the invention.

Decompensation starts with stable patients whose cardiac function is at baseline as shown by 121. Several drugs have been shown to stabilize ventricular function. As shown by 131, inadequate use of digoxin, beta-blockers, angiotensin converting enzyme inhibitors (ACEs), angiotensin receptor blocking agents (ARBs), and spironolactone can lead to deterioration of LV performance. The prescribed doses may be too low or the patient's adherence to prescribed doses may be poor. This problem may be prevented by an outpatient drug monitoring program 141.

Early decompensation 112 is associated with salt and water retention 122. Patients who gain more weight before admission may have a higher risk of relapse than those who gain less because, for a given amount of diuresis, they will have made less progress towards their baseline. A volume overload 132 can be averted by teaching patients to titrate their diuretics based upon daily weights 142.

Hospital admission 113 is often precipitated by dyspnea—a manifestation of left atrial hypertension 123. The prognosis is worse for those whose treatment does not address multiple mechanisms of injury 133, for example, volume overload, mitral valve disease, and LV diastolic dysfunction. The problem could be resolved by a systematic evaluation of cardiac hemodynamics and a customized treatment protocol based upon the findings 143. In addition to diuresis, the latter might include afterload reduction, valve replacement, and reversal of cardiac ischemia.

Most inpatient care 114 is devoted to reducing extracellular fluid volume 124. Patients may relapse if they are discharged prematurely with inadequate diuresis 134. The solution would be to change discharge criteria from those that are symptom-based to one that is based upon the underlying physiology. An example of the latter is the degree to which a patient has achieved his or her dry weight. 144.

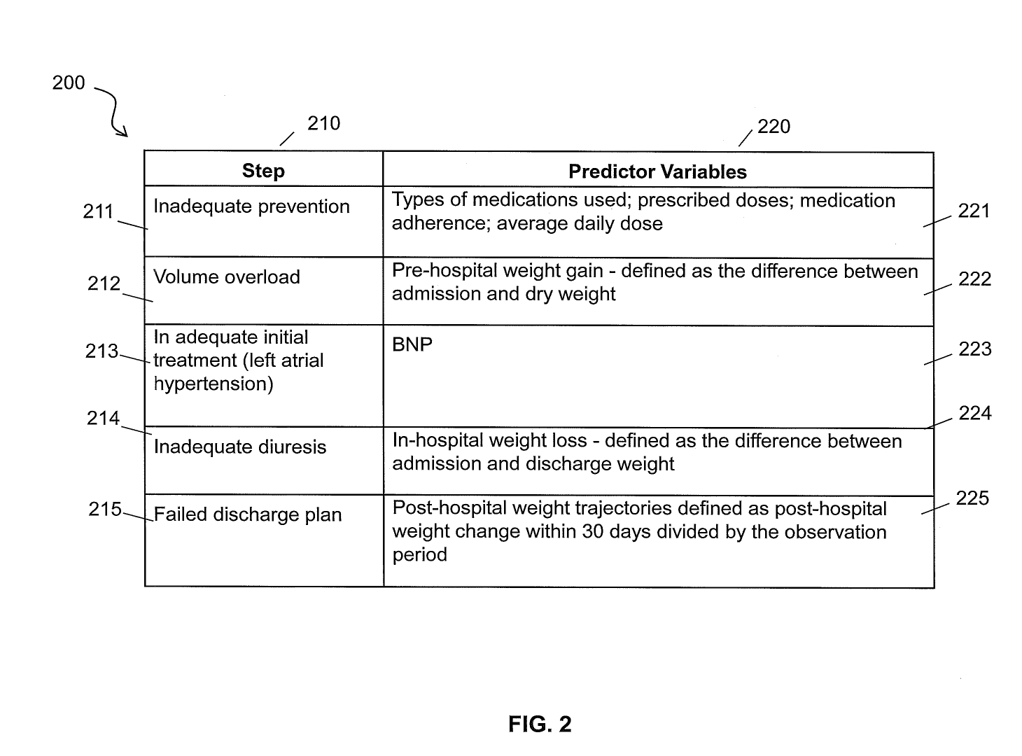

Finally, the goal of post-hospital care 115 is to restore baseline LV function 125. This treatment may fail if there is no attempt to correct the factors that precipitated the initial episode including dietary indiscretion or medication adherence 135. These patients should be enrolled to supervised post-hospital care 145. The invention includes a formulation to measure the patient's status at each phase of illness 110. The invention determines if the measures taken during the index hospitalization forecast a relapse within 30 days using the metrics shown in FIG. 2. The block diagram 200 shown in FIG. 2 illustrates the failure modes in column 210 and the corresponding prediction variables 220.

The failure mode directed to inadequate prevention 211 uses the predictor variables 221 directed to types of medications used, prescribed doses, medication adherence, and average daily dose.

The failure mode directed to volume overload 212 uses the predictor variable 222 directed to pre-hospital weight gain. Pre-hospital weight gain is defined as the difference between admission and dry weight, which can be expressed as the fractional gain at admission over the dry weight.

The failure mode directed to inadequate initial treatment 213 of left atrial hypertension uses the predictor variables 223 directed to brain natriuretic peptide (BNP).

The failure mode directed, to inadequate diuresis 214 uses the predictor variables 224 directed in-hospital weight loss. In-hospital weight loss is defined as the difference between admission and discharge weight, which can be expressed as the proportion of the excess weight lost during the hospitalization.

The failure mode directed to a failed discharge plan 215 uses the predictor variables 225 directed to post-hospital weight trajectories. Post-hospital weight trajectories are defined as post-hospital weight change within 30 days divided by the observation period.

The invention finds all patients who have ever qualified for the diagnosis of CHF in order to create a database that can be used for research. Some patients are followed for 17 years—far longer than the longest clinical trials. Thus, the database of data represents a unique opportunity to examine the relationship between long-term risk factor control and LV function.

A processor accesses data from one or more disparate sources to create a database of data that may be stored in a main memory or secondary memory. The data warehouse includes data of patients of a patient population. Although the invention in discussed with respect to the VISN 18 Data Warehouse (VDW), any data warehouse is contemplated. The invention uses the following tables from the VDW warehouse:
Chem.LabChem—laboratory tests
Dim.ICD—dimension table for ICD-9 codes
Dim.LabChemTest—dimension table for laboratory test names
Dim.NationalDrug—dimension table for the National Drug Index
Inpat.InpatientDiagnosis—hospital discharge diagnoses
Outpat.VDiagnosis—outpatient encounter diagnoses
Outpat.ProblemList—outpatient problem lists
PCMM.PatientProviders—primary care assignments
RxOut.RxOutpatfill—outpatient prescriptions
SPatient.SPatient—patient variables
SStaff.SStaff—staff variables
Vital.VitalSign—vital signs (includes pulse, blood pressure, weight, and height)

All tables except for those labeled “dim”—Dim.ICD, Dim.LabChemTest, Dim.NationalDrug—contain patient or provider data. Dimension tables are references that contain detailed information on “keys” in data tables. They allow the user to join additional fields (such as standard codes or names) to data tables through appropriate linkages. For example, Outpat.VDiagnosis contains only a reference to the encounter diagnosis called “ICDSID”.

The processor retrieves data relating to one or more patients from the data warehouse to obtain a database of patient records. The processor sorts the records according to a diagnosis such as CHF. To obtain the actual diagnosis, the user must join Outpat.VDiagnosis to Dim.ICD on “ICDSID”. The corresponding ICD-9 code and description can then be brought into the data table.

In VDW, diagnoses are classified according to the International Classification of Diseases, 9^{th} revision (ICD-9). The following codes are used for clinical diagnoses in discharge summaries, outpatient encounters, and problem lists:

| | |
|---|---|
| 398.91 | RHEUMATIC HEART FAILURE |
| 402.01 | HYP HEART DIS MALIGN WITH FAIL |
| 402.11 | HYP HEART DIS BENING WITH FAIL |
| 402.91 | HYP HEART DIS UNSP WITH FAIL |
| 404.01 | MAL HYP HRT/KIDNEY W HF |
| 404.03 | MAL HYP HRT/KID W HF/KID |
| 404.11 | BEN HYP HRT/KID W HF |
| 404.13 | BEN HYP HT/KID W HF/KID |
| 404.91 | HYP HRT/KID NOS W HF |
| 404.93 | HYP HRT/KID NOS W HF/KID |
| 428.0 | CONGEST HEART FAIL UNSPECIFIED |
| 428.1 | LEFT HEART FAILURE |
| 428.20 | UNSPEC SYSTOL HEART FAILURE |
| 428.21 | ACUTE SYSTOLIC HEART FAILURE |
| 428.22 | CHRONIC SYSTOLIC HEART FAILURE |
| 428.23 | ACUTE ON CHRON SYST HEART FAIL |
| 428.30 | UNSPEC DIASTOL HEART FAILURE |
| 428.31 | ACUTE DIASTOLIC HEART FAILURE |
| 428.32 | CHRON DIASTOL HEART FAILURE |
| 428.33 | ACUTE ON CHRON DIAST HEART |
| 428.40 | UNSP COM SYST & DIAST HEART |
| 428.41 | ACUTE COM SYST & DIAST HEART |
| 428.42 | CHRON COM SYST & DIAST HEART |
| 428.43 | ACUT CHR COM SYST& DIAST HEART |
| 428.9 | HEART FAILURE NOS |

Although the list includes biventricular and LV failure, but not RV failure or pulmonary heart disease, the invention retrieves cases of systolic and diastolic dysfunction.

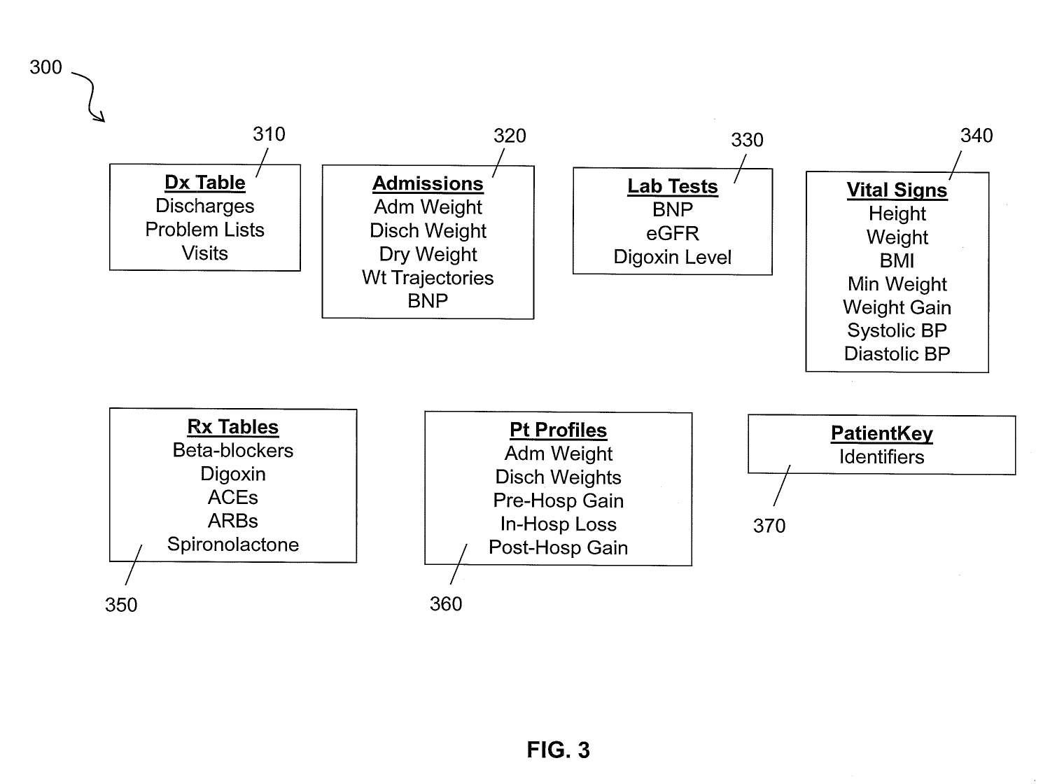

The processor obtains patient variables from the data warehouse and joins the variables to the patient records. The invention is programmed in a modular format. FIG. 3 illustrates a block diagram 300 of modules for identifying and evaluating patient variables related to a diagnosis such as congestive heart failure that may be used to predict a re-admission rate according to one embodiment of the invention. The modules include a DxTable module 310, an Admissions module 320, a LabTests module 330, a VitalSigns module 340, a RxTable module 350, a PtProfiles module 360, and a PatientKey module 370.

DxTable module 310 provides diagnostic criteria met by patients. DxTable module 310 contains all patients who have ever been given the diagnosis of CHF. DxTable module 310 may be used to provide an admission date and a discharge date of each hospitalization. DxTable module 310 may also be used to select patients who have never been hospitalized. It can also be used to assemble a study on the natural history of CHF or long-term outcomes of treatment.

A patient is considered to have CHF if he/she was given a relevant diagnosis on hospital discharge, an outpatient visit, or a problem list. The invention does not distinguish between primary and secondary diagnoses. The reason is that these designations are often used to maximize workload credit than to rate their overall importance. DxTable module uses the earliest of the criteria dates as the date of diagnosis and counts the number of criteria met. The final table contains the following fields:
PatientSID—patient surrogate identification number (primary patient key)
Sta3n—facility number
DxCount—number of diagnostic criteria met (maximum=3)
DxDate—date of diagnosis defined as the earliest of the first discharge, outpatient or problem list entry
DischDate—discharge date for the first hospitalization for CHF
DischlCDCode—ICD-9 code for the first hospitalization for CHF
DischICDText—standard ICD-9 description for the first hospitalization for CHF
VisitDate—encounter date for the first outpatient visit for CHF
VisitICDCode—ICD-9 code for the first outpatient visit for CHF
VisitICDText—standard ICD-9 description for the first outpatient visit for CHF
ProbDate—date of entry for the first problem list diagnosis for CHF
ProbICDCode—ICD-9 code for the first problem list diagnosis for CHF
ProbICDText—standard ICD-9 description for the first problem list diagnosis for CHF

Admissions module 320 contains all hospitalizations for which CHF is listed as a discharge diagnosis and includes one or more weight measurements. It contains the date/time of admission and discharge, length of stay, admission and discharge weight (if any), most recent pre-hospital dry weight, fractional weight changes, and the closest BNP to admission and/or discharge. Each hospitalization is “self-joined” to the subsequent one if the interval between them is less than or equal to 30 days. Each admission can therefore be labeled as a “success” or “failure”. For re-admitted patients, Admissions module 320 calculates the interval weight change and a “weight trajectory”. The latter is defined as the weight change divided by the number of hours between the index discharge and next admission. For comparative purposes, the invention also calculates a weight trajectory for patients not re-admitted by identifying the weight closest to 30 days of follow-up and performing the same calculation. Admissions module 320 creates the data set used for explanatory modeling. The remaining tables support the treatment of active patients.

More specifically, Admissions module 320 contains all hospitalizations in which a relevant ICD-9 code was listed as either a primary or secondary diagnosis. It is obtained by applying the ICD-9 search template to Inpat.InpatDiagnosis. The invention retrieves the admission and discharge dates and assigns a primary key (DischID) to each record. Weight measurements are then linked to each admission (if available). The invention performs sophisticated analyses on data in the vital sign table of VDW including systolic blood pressure, diastolic blood pressure, body weight, and body mass index (BMI). The invention purges data that are physiologically implausible using heuristics developed by informatics faculty.

The invention uses a novel strategy to purge standard weight values from data sets extracted from VDW using a “jack-knife” technique to test each value against the arithmetic mean of all values except for the one in question. This task is accomplished by deriving the number and average of all values for a given patient. For each weight, these values are used to calculate the average of the remaining values. If “weight” represents the value in question, the average of the remaining values (AvgOfOtherValues) is given by:

(CountWt*AvgWt−weight)/(CountWt−1)

where CountWt is the number of weight measurements and AvgWt is the mean value of all weights in the patient's record. The module then deletes weights where:

(Weight−AvgOfOtherValues)/(AvgOfOtherValues)≧+0.30 or ≦−0.30

The single value is retained for those with only one measurement. As an example, for a 200 pound man, values less than 140 or greater than 260 are purged. It is highly unlikely that weights would fluctuate beyond that range with CHF. However, massive weight loss or gain can occur in other conditions. Users should be aware that this technology is not applicable to patients with bariatric surgery, severe catabolic conditions, or extremity amputations.

With respect to assignment of admission and discharge weight, the invention assigns an admission weight to each hospitalization by linking the Admissions module 320 to the standard weight file on the primary patient key (PatientSID). The join is allowed if the weight was measured no more than 10 days prior to or more than 12 hours after admission. Qualifying values are then ranked by the absolute value of the weight-to-admission interval (WtToAdm). The weight with the smallest WtToAdm (i.e. in closest proximity to admission) is considered the admission weight. The same procedure is followed for discharge weight except that the join is allowed if the weight is measured no more than 24 hours before or after discharge. In-hospital weight loss is defined as the difference between the admission and discharge values.

Dry weight is defined as the patient's optimal value—that is, the minimum weight that is not associated with hypotension or renal impairment. With respect to the assignment of dry weight, values higher than dry weight suggest that the patient is volume overloaded while lower values imply that the patient is dehydrated. For a given patient, the optimal weight may increase with time. As LV function deteriorates, higher filling pressures (and extracellular fluid volumes) are required to maintain cardiac output and renal perfusion. As a result, dry weight has to be re-calculated for each admission using values in relatively close proximity to the event. The invention does a “look-back” at all weights linked to blood pressures (BPs) and serum creatinines (SCrs) within 365 days of the admission. It then selects one of those values as the patient's dry weight for the hospitalization.

The first step is to create a dry weight file—that is, weights that are linked to BP and SCr measurements. This module joins all values in the standard weight file to available systolic BPs for the same patient as long as the weight was measured no more than 30 days before or after the BP was taken. The joined values are then ranked by the absolute amount of time between the two measurements (WtToBP). The BP with the smallest WtToBP (i.e. in closest proximity to the weight) is then assigned to that weight. The process is repeated for SCr except that the link is permitted only if the SCr measurement is no more than 60 days prior to or after the weight. The output is a dry weight file consisting of all weights linked to their closest BPs and SCrs, referred to as a “triad”.

The assignment of a dry weight to each admission is a sophisticated process. It begins by linking the admission to records to triads in the dry weight file on PatientSID. The join is allowed as long as the dry weight is taken no more than 365 days before the hospitalization. The next step consists of purging triads within this range if the weight deviates by more than 30% of the average of the remaining values. This procedure is described above. Next, the module identifies the lowest SCr in the range of values, appends this value to the other triads, and calculates the difference between each Scr and the minimal value. The module then removes any entries if the systolic BP is less than 100, the minimal SCr is less than 1.2 and observed SCr is greater than or equal to 30% higher than the minimal value, or the minimal SCr is greater than or equal to 1.2 and less than 1.5 and the observed SCr is greater than or equal to 0.25 higher than the minimal value, or the minimal SCr is greater than or equal to 1.5 and the observed SCr is greater than or equal to 0.20 higher than the minimal value.

The latter procedure allows some tolerance before a SCr is considered a significant impairment over the minimal value. The output of this procedure is a file consisting of triads taken within 365 days of admission at a time that the patient was not hypotensive or had a significant increase in SCr over his/her 365-day minimum. Finally, the invention identifies the lowest weight among these triads and assigns that value to each admission as that patient's dry weight. Pre-hospital weight gain is defined as the difference between the admission and dry weights.

In order to identify re-admissions, the invention determines whether an index admission is a “success” or “failure” by joining each hospitalization to the subsequent one. This join is permitted only if the interval between the index discharge and next admission dates is less than or equal to 30 days. Successful hospitalizations are those in which no joins have occurred, while unsuccessful ones are those in which consecutive admissions are paired. It is simple to update the file by assigning “0” to the former and “1” to the latter to serve as the dependent variable for a logistic model.

With respect to admission and discharge BNP, BNPs are joined to each admission as long as it as measured no more than 12 hours prior to or more than 24 hours after the admission date. Records are sorted by the absolute value of the interval between the BNP and admission (BNPToAdm). The BNP with the smallest BNPToAdm (i.e. in closest proximity to admission) is considered the admission BNP. Discharge BNP is handled the same way except that eligible BNPs are no more than 24 hours prior to or no more than 12 hours after discharge.

Turning to post-hospital weight trajectories, a “weight trajectory” is defined as a change in weight divided by the observation period. For paired hospitalizations (i.e. treatment failures), the weight change is the difference between the index discharge weight and the re-admission weight. The observation period is the number of days between the index discharge and re-admission. The trajectory therefore determines the rate at which weight changes in the post-hospital period. For comparative purposes, a weight trajectory is calculated for patients not re-admitted. It does so by identifying the weight closest to 30 days after discharge, calculating the change from the discharge weight, calculating the number of days between the hospital discharge and weight measurement, and dividing the former by the latter. The Admissions module 320 contains the following variables:
PatientSID—patient surrogate identification number (primary patient key)
Sta3n—facility number
DischID—primary key for the admissions table
AdmDate1—admission date and time for the index hospitalization
DischDate1—discharge date and time for the index hospitalization
LOS1—length of stay for the index hospitalization
AdmWtDate1—date that admission weight was measured for the index hospitalization
AdmWt1—value of the admission weight for the index hospitalization
WtToAdm1—interval (in hours) between the admission weight measurement and hospitalization
DischWtDate1—date that the discharge weight was measured for the index hospitalization
DischWt1—value of the discharge weight for the index hospitalization
DischToWt1—interval (in hours) between the discharge weight measurement and hospital discharge
DryWtDate1—date that the dry weight was measured for the index hospitalization
DryWt1—value of the dry weight assigned to the index hospitalization
DryWtToAdm1—interval (in days) between the dry weight measurement and the index hospitalization
PreWtGain1—difference between the admission weight and dry weight for the index hospitalization
HospWtLoss1—difference between the admission and discharge weight for the index hospitalization
AdmDate2—date of re-admission (if any). If present, the index hospitalization was followed by a re-admission ≦30 days after discharge
DischDate2—date of discharge for the re-admission (if any)
LOS2—length of stay for the re-admisison
AdmWtDate2—date of the admission weight measurement for the re-admission
AdmWt2—value of the admission weight measurement for the re-admission
WtToAdm2—interval (in hours) between the admission weight measurement and the re-admission
DischWtDate2—date that the discharge weight was measured for the re-admission
DischWt2—value of the discharge weight for the re-admission
DischToWt2—interval (in hours) between the discharge weight measurement and hospital discharge
DryWtDate2—date that the dry weight was measured for the re-admission
DryWt2—value of the dry weight assigned to the re-admission
DryWtToAdm2—interval (in days) between the dry weight measurement and re-admission
FUInt—interval (in days) between the index discharge and date of re-admission
IntHospGain—difference between the re-admission weight and index discharge weight
FUWtDate—date of the weight measurement closest to 30 days of the index discharge
FUWt—value of the weight measurement closest to 30 days of the index discharge
DischToFUWt—interval (in days) between the index discharge and follow-up weight
FUWtRate—weight trajectory; defined as IntHospGain/FUInt for re-admitted patients; defined as (FUWt—index discharge weight)/DischToFUWt for patients not re-admitted
AdmBNP—BNP in closest proximity to the admission
DischBNP—BNP in closest proximity to the discharge
FracGain—percent increase in body weight at the time of hospitalization; defined as PreWtGainl/DryWeight1
FracLoss—percent of excess weight lost during the hospitalization; defined as HospWtLossl/PreWtGain1

LabTests module 330 retrieves the most recent laboratory results including, for example, serum digoxin, estimated glomerular filtration rate (eGFR), and brain natriuretic peptide. Digoxin level is included for patients treated early in the search period. Glomerular filtration is important because renal dysfunction is a marker for poor cardiac performance and often limits the degree to which diuretics, ACEs, and ARBs can be used. The latest BNP is an indicator of recent cardiac dysfunction.

LabTests module 330 retreives the most recent values for laboratory results. Like other modules, a substantial proportion of the programming is dedicated to “scrubbing” laboratory results. The invention uses its own parsing functions to convert entries in the text results field to numeric values. It does so because the type conversion procedures used by VDW return a NULL value if the text field contains any non-numeric character. As a result, the most critical values such as “>18.6%”, “5.6”, “1.9 H”, or “13.5 (results called to physician)” will be missed by searching the converted field (called ResultsNumeric). LabTests module 330 circumvents the problem by converting out-of-range to their boundary values, replacing letters and punctuation with spaces, trimming leading and trailing spaces, and converting the resulting string to a double precision number. Conversion will appropriately fail if there is an embedded space indicating the presence of 2 or more numeric values in the results field. The module replaces these entries with the error code “999999999”. The following parameters are available in LabTests module 330:
PatientSID—patient surrogate identification number (primary patient key)
CrDate—date of the most recent creatinine determination
Creat—value of the most recent creatinine determination
DigLevDate—date of the most recent digoxin level
DigLevel—value of the most recent digoxin level
BNPDate—date of the most recent BNP
BNP—value of the most recent BNP

More specifically, the invention retrieves test results for digoxin level, eGFR, and BNP by searching for relevant laboratory test names. Although Logical Observation Identifier Names and Codes (LOINC) is supported by VDW, this coding system is not used consistently for laboratory tests across facilities. Instead, the invention identifies candidate test names by searching Dim.LabChemTest for root syllables, abbreviations, acronyms, and synonyms. For example, the search for hemoglobin A1c might include ‘% a1c%’, ‘HbA1c’, or ‘% glyco%’ (for glycohemoglobin) where % represents a wild card. The resulting list is then manually reviewed for appropriate entries and stored as a search template. It should be noted that a new test name is assigned whenever an assay is changed. The list of test names should therefore be updated on a regular basis.

Studies have shown that the use of diuretics, beta-blockers, ACEs, ARBs, and spironolactone stabilize ventricular performance. In many cases, the use of these medications is limited by hypotension and bradycardia. The invention presents the most recent set of vital signs to users considering intensification of therapy through the VitalSigns module 340.

Systolic and diastolic blood pressure are handled the same way as they are in routine practice. In a clinic, the BP is measured several times if the initial reading is elevated. The rationale is that transient elevations may occur because the patient has just walked in. If he/she has a diminished vascular reserve, the increased cardiac output associated with exercise will increase the systemic BP—a transient abnormality that will resolve when the patient's cardiac output decreases with rest. Another explanation is that the patient may have “white coat” hypertension—that is, a stress response associated with a threatening environment. Elevated catecholamines may normalize as the patient becomes familiar with his/her surroundings. The lowest value of the multiple readings is usually entered into the medical record. The invention carries this process one step further. Although all BPs are retrieved, it uses only the lowest in each 24-hour period starting at midnight. It does so by converting the data type for dates to decimal, using the FLOOR command to strip the decimal places (which represent time of day), re-casting the result as DATETIME, grouping the data set by PatientSID and the new DATETIME, and retaining the lowest value. The retained BPs are therefore the “best-case” scenarios in patients with hypertension but the “worst-case” scenarios in patients with hypotension. Systolic and diastolic BPs are handled identically. Patient height is the least reliable vital sign. In many cases, the value is not recorded; the patient is asked about his/her height in lieu of a measurement; the last value is carried forward; the value is entered in units other than inches; and wrong vital signs are entered in the height field. For this reason, values less than 42 inches (3 feet 6 inches) or greater than 90 inches (7 feet 6 inches) are purged. The lifetime average height is used for BMI calculations.

VitalSigns module 340 obtains a variety of vital signs including the most recent weight and its deviation from the lowest value in the preceding 12 months. Blood pressures are included because hypotension also limits the extent to which diuretics and anti-hypertensives can be used. VitalSigns module 340 retrieves one or more vital signs, for example, all patient weights within 730 days of the query date and excludes values less than or equal to 80 pounds or greater than or equal to 600 pounds. It identifies the minimal weight for the remaining values as well as the deviation of the most recent weight from the 2-year minimum. VitalSigns module 340 uses the following formula to calculate patient BMI:

730*LastWeight/AvgHeight̂2

The following variables are available in VitalSigns module 340:
PatientSID—patient surrogate identification number (primary patient key)
PulseDate—date of the most recent pulse
Pulse—value of the most recent pulse
AvgHeight—arithmetic mean of all heights in the patient's medical record
WeightDate—date of the most recent weight
LastWeight—value of the most recent weight
BMI—most recent body mass index; calculated from AvgHeight and
LastWeight
MinWeight—lowest weight in the preceding 730 days
WeightDev—difference between the most recent weight and MinWeight
SystBPDate—date of the most recent systolic blood pressure
SystBP—value of the most recent systolic blood pressure
DiasBPDate—date of the most recent diastolic blood pressure
DiasBP—value of the most recent diastolic blood pressure

RxTable module 350 contains the latest course of treatment (if any) for each drug class of heart failure drugs for every active patient. A treatment course is defined as an uninterrupted sequence of prescriptions for a generic drug at a specific daily dose. The table contains the most recent prescription, prior prescription, start date, short-term and long-term adherence, treatment duration and average daily dose.

The invention uses the VA's drug class code consisting of two parts. The first 2 letters refer to the organ system, while the next 3 digits refer to the mechanism of action. This system allows users to search for related drugs quickly and thoroughly. Searching for prescriptions in a drug class is done by joining records in RxOut.RxOutpatfill to Dim.NationalDrug on the key NationalDrugSID. The class is contained in the field labeled PrimaryDrugClassCode in Dim.NationalDrug. The invention retrieves drugs in the following drug classes:

| | |
|---|---|
| CV050 | digoxin |
| CV100 | beta-blockers |
| CV704 | spironolactone |
| CV800 | angiotensin converting enzyme inhibitors (ACEs) |
| CV805 | angiotensin receptor blocking agents (ARBs) |

The invention provides the user a detailed analysis of the most recent “treatment course” for each drug class including generic drug name, prescribed daily dose, last prescription, prior prescription, average daily dose, and short-term and long-term adherence. A treatment course is defined as an uninterrupted sequence of prescriptions given to a patient for a specific dose of a generic drug.

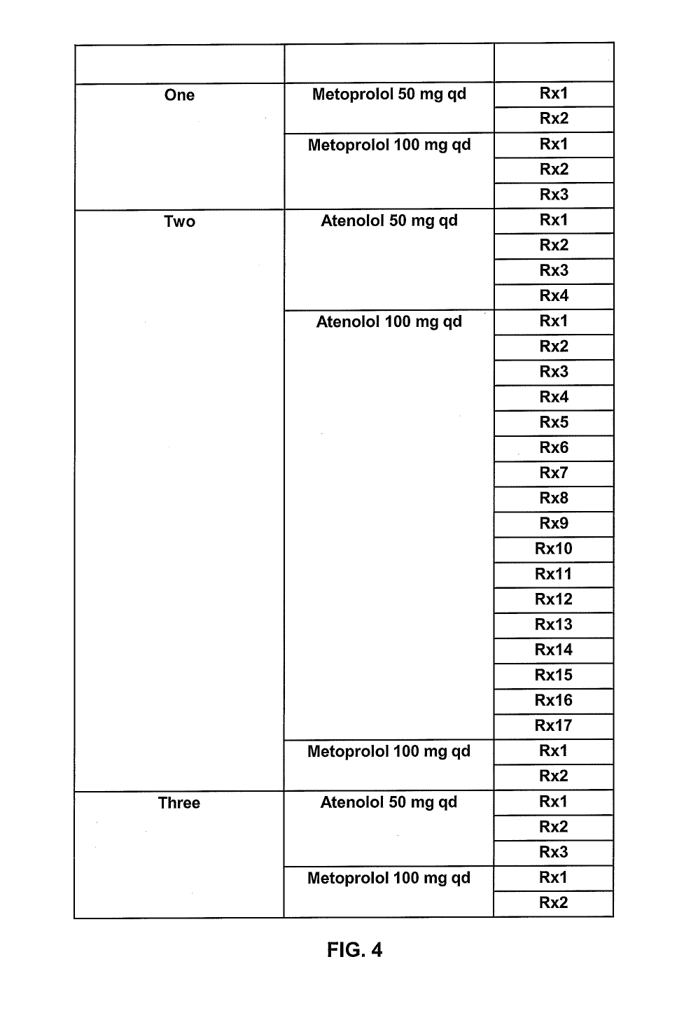

FIG. 4 illustrates a table of prescriptions organized into courses according to one embodiment of the invention. As can be seen, Patient Two has received 3 courses of beta-blockers each of which is characterized by a unique combination of drug and dose. Creating a treatment course requires more than assembling the prescriptions for a formulation because of variation in the number of tablets taken daily. For example, a patient on 40 mg of simvastatin daily could be given ½ dose of an 80 mg tablet, one dose of a 40 mg tablet, two doses of a 20 mg tablet, or four doses of a 10 mg tablet each day. A patient switched through the 4 formulations (10-, 20-, 40-, and 80-mg tablets) would still be on one treatment course of simvastatin 40 mg daily. On the other hand, a patient taking one dosage form could progress through different treatment courses depending upon the number of tablets taken daily. The invention solves this problem by converting the dosage form, quantity dispensed, and days' supply of each prescription into the prescribed daily dose of the corresponding generic. The first step is to construct a reference table from the standard field “drug name with dose” in the National Drug Index. Single formulation and combination pills are handled separately. For the former, RxTable module 350 generates 3 replicates of “drug name with dose” in the table, extracts the drug name as the generic from the second field, and removes letters from the third using a parsing function described in previous sections. The third field is “cast” as a numeric and represents the tablet strength.

The daily dose represented by each prescription can then be calculated from the following expression:

Quantity*Tablet Strength/ Days' Supply

where Quantity and Days' Supply are taken from the prescription and Tablet Strength is taken from the reference table joined to each prescription through “drug name with dose”. The same procedure is used for combination pills except that tablet strength is given a value of 1 so that daily dose is expressed as pills per day. The tables for single formulations and combination pills are then merged. Prescriptions are sorted by PatientSID, generic name, daily dose, and prescription date and assigned an index number.

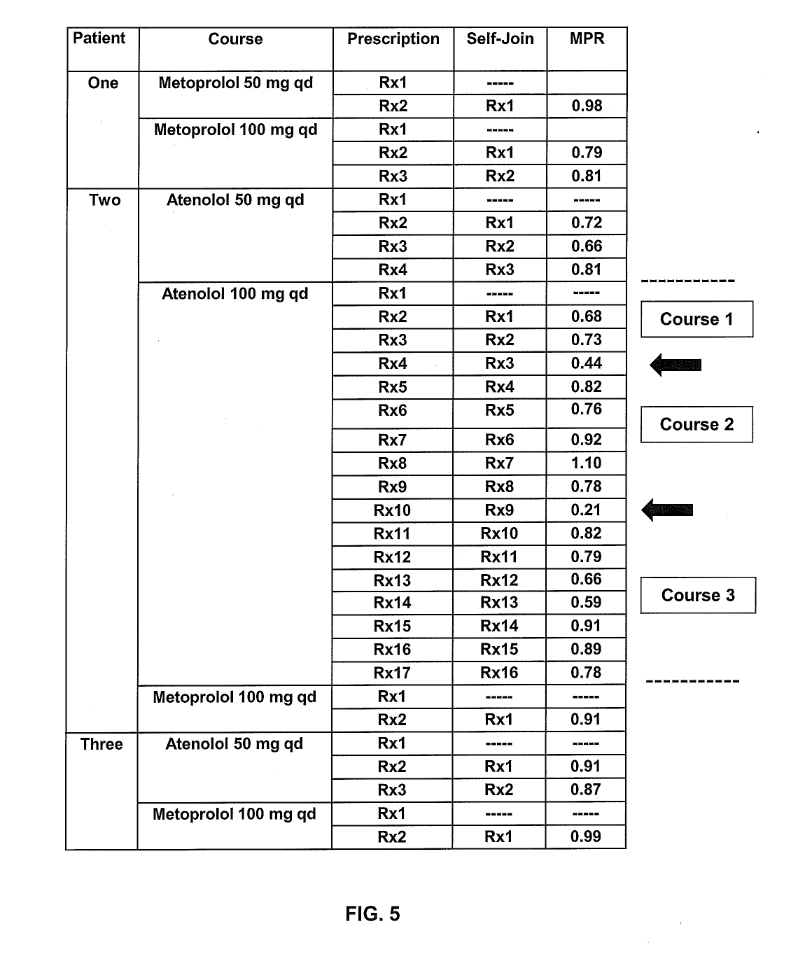

Drugs are often stopped and re-started because of fluctuations in the patient's status. To identify interruptions in treatment, RxTable module 350 uses the index number to join each prescription to the preceding one (or “self-join”) as long as the patient, generic, and daily dose are the same (see FIG. 5). For each pair of prescriptions, the module calculates the medication possession ratio (MPR)—defined as the proportion of days for which the patient has taken the prescribed dose. MPR is given by:

### Prior Days' Supply/Days Between the Prior and Last Fill

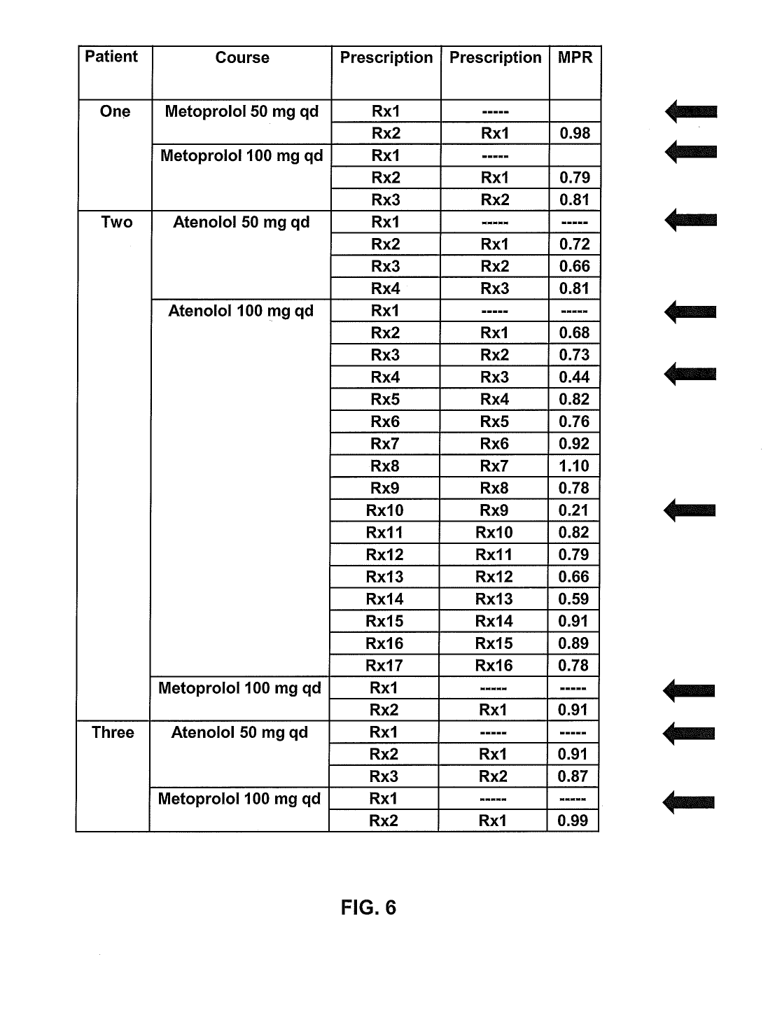

RxTable module 350 evaluates each pair of prescriptions and treats those with MPR less than 0.5 as interruptions in treatment. This definition can easily be changed to meet the user's needs. For example, the criterion can be increased or decreased or an interruption can be identified by a “gap” of untreated days. As shown in FIG. 5, Patient Two has had 2 interruptions in treatment (shown by arrows) and therefore 3 separate courses of atenolol _100 mg qd. The RxTable module 350 then identifies all treatment changes including new treatments as well as new trials of older ones. In FIG. 6, Patient Two has had 5 treatment changes (one for atenolol 50 mg qd, three for atenolol 100 mg qd, and one for metoprolol 100 mg qd).

RxTable module 350 considers the last treatment change for each patient as the start of the last course and generates summary statistics for that course. RxTable module 350 does not determine whether the changes are appropriate because it does not ascertain the rationale from the clinician's progress notes. Even a down-titration of a BP med might be appropriate for an elevated value. For example, suppose that a well-controlled patient has side-effects from 40 mg of lisinopril and stops the drug. The next BP may be elevated. If so, the appropriate response is to re-start the medication at 20 mg qd. Thus, a reduction in the prescribed dose from 40 mg to 20 mg is an appropriate response to an elevated BP. RxTable module 350 uses copies of one routine to perform the same analysis for each drug class. The following fields are available for each drug class in RxTable module 350:
PatientSID—patient surrogate identification number (primary patient key)
Drug—name of the medication
RxDose—prescribed daily dose
LastRx—release date and time of the last presription in the treatment course; defined as the date that the prescribed supply was removed from the pharmacy inventory and custody transferred to the patient
LastSupp—days' supply provided by the last prescription in the treatment course
LastRxGone—date that the supply provided by the last prescription is expected to be gone
PriorRx—release date and time of the prior prescription (next-to-last) in the treatment course defined as the date that the presribed supply was removed from the pharmacy inventory and custody transferred to the patient
PriorSupp—days' supply provided by the prior (next-to-last) prescription in the treatment course
RxInt—interval (in days) between the last and prior prescriptions in the treatment course
ShortMPR—medication possession ratio for the last 2 prescriptions in the treatment course; defined as the proportion of days for which the patient has enough medication to take the prescribed dose
ShortDose—average daily dose; defined as the amount of drug provided by the prior prescription divided by the interval (in days) between the last and prior pressriptions
RxStart—release date and time for the first prescription in the last treatment course
RxDur—time on treatment; defined as the interval (in days) between the release dates for the first and last prescriptons in the treatent course
LongMPR—average medication possession ratio over the last course of treatment; defined as the proportion of days for which the patient has enough medication to take the prescribed daily dose
LongDose—average daily dose; defined as the amount of drug dispensed divided by time on treatment

RxTable module 350 contains summary data for the last treatment courses for all 5 drugs classes. Each record represents one patient Prefixes are attached to the field names (above) to indicate the drug class: “dig”=digoxin; “BB”=beta-blockers; ACE=angiotensin converting enzyme inibitor; ARB—angiotensin receptor blocking agent; SPIR=“spironolactone”. Thus, SPIRLongDose is the average daily dose over the last treatment course for spironolactone. For research purposes, RxTable module 350 retains all treatment courses for each class in separate tables. One patient may have several records each of which represents one treatment course. These tables can be used to identify practice patterns or to construct data sets for explanatory modeling. For example, to analyze the effect of beta-blocker use on CHF re-admission, the user would join treatment courses in the beta-blocker table to each hospitalition in Admissions module 320 on PatientSID-provided that RxStart antedates the admission date and RxGone follows it. This condition assures that the patient was on a beta-blocker at the time of admission.

Turning back to FIG. 3, PtProfiles module 360 contains a summary of all hospitalizations for each patient. The fields include number of admissions; number of relapses; and average values for the following: admission, discharge, and dry weights; pre-hospital weight gain and fractional increment over dry weight; in-hospital weight loss and fractional loss of pre-hospital weight gain; and post-hospital weight trajectories. The invention also stores information on all treatment courses given to all patients. These records can be joined to index hospitalizations or re-admissions through a primary patient key referred to as “PatientSID”. This link enables the user to test the hypothesis that the use of these medications reduces the risk of relapse. Finally, the data tables do not contain patient identifiers. Joining any table to the PatientKey module 370 through PatientSID allows the user to add such information and select those currently assigned to primary care providers.

The invention provides profiles for all patients admitted for CHF using PtProfiles module 360. These profiles allow the user to identify patterns in hospital data that may warrant a specific intervention. For example, some patients may gain excessive weight prior to admission, others may have inadequate weight loss during their hospital stay, while still others may have a positive weight trajectory after discharge. These patients may benefit from ongoing weight monitoring and diuretic self-titration, revised discharge criteria, and supervised post-hospital care, respectively. The following fields are contained in PtProfiles module 360:
PatientSID—patient surrogate identification number (primary patient key)
NumHosp—number of hospitalizations for CHF
Avg LOS—average length of stay for CHF
AvgAdmWt—average admission weight (in pounds)
AvgDischWt—average discharge weight (in pounds)
AvgDryWt—average dry weight (in pounds); defined as the minimum weight in the preceding 365 days not associated with BP<100 mm Hg or azotemia
AvgPreGain—average weight gain on admission (in pounds) over dry weight
AvgFracGain—average fractional increase over dry weight at the time of admission; defined as Avg[(AdmWt−DryWt)/DryWt]
AvgHospLoss—average weight loss for all CHF hospitalizations
AvgFracLoss—average fractional loss of weight (in pounds) over all CHF hospitalizations; defined as Avg[(AdmWt−DischWt)/PreWtGain]
AvgPostRate—average rate of change in weight after discharge; for relapses, defined as (AdmWt2−DischWt1)/(AdmDate2−DischDate1) and expressed in pounds/hour; for non-relapses, defined as (FUWt−DischWt1)/(FUWtDate−DischDate1) where FUWt is the measurement closest to 30 days after discharge
AvgAdmBNP—average admission BNP over all CHF hospitalizations
AvgDisBNP—average discharge BNP over all CHF hospitalizations
NumRelapse—number of relapses; defined as readmissions within 30 days

Patients currently assigned to a primary care physician can be identified by joining the output of any query to the PatientKey module 370 through PatientSID. The module searches for assignments. In the rare circumstance where there are two assignments, the key picks the one with the most recent RelationshipStartDate. The PatientKey module 370 contains the following fields:
PatientSID—patient surrogate identification number
PatientName—last name followed by first and middle
PatientSSN—patient social security number
PatientGender—identified as either “M” or “F”
PatientAge—in years up to the query date
PCPName—last name followed by first and middle
Team—primary care team
Sta3n—station number

It was found that hospitalizations ending in relapse were slightly longer in duration and associated with larger pre-hospital weight gain, larger fractional weight gain, smaller in-hospital weight loss, smaller fractional losses, higher admission BNP, higher discharge BNP, and a positive weight trajectory after discharge. Thus, all parameters except the absolute weights were predictors of a poor prognosis.

Logistic regression was used to determine which variables were independent predictors of relapse. Admission BNP and fractional hospital weight loss were identified as independent predictors. In summary, all of the variables used in the invention distinguish hospitalizations that end in relapse from those that do not. Because of this finding, patients with worrisome findings in each of 5 categories (pre-hospital weight gain, in-hospital weight loss, admission BNP, discharge BNP, and post-hospital weight trajectory) may be considered for the interventions previously described.

Based on the one or more patient variables, the processor provides a patient profile for each diagnosed patient record of the set. One or more patient profiles are identified that match a failure mode (see FIG. 1 and FIG. 2). The failure mode is assigned by the processor to each patient profile and a solution is provided for the failure mode.

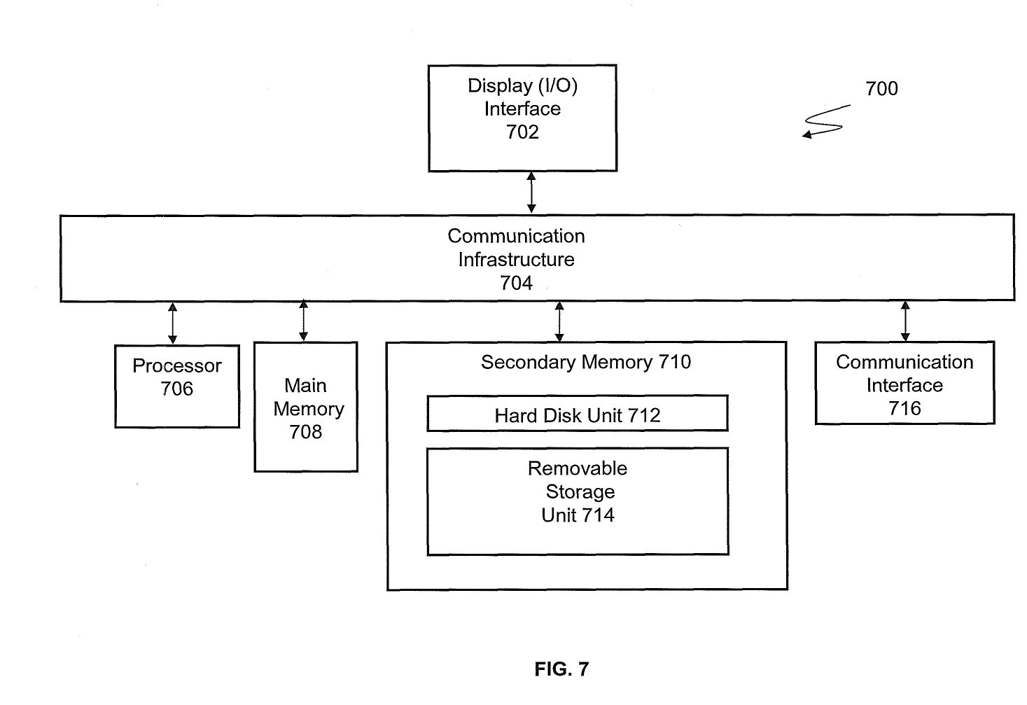

In one embodiment, the invention is programmed in Microsoft SQL Server and can be set to update daily. FIG. 7 illustrates an exemplary computer system 700 that may be used to implement the programs according to the invention.

Computer system 700 includes an input/output display interface 702 connected to communication infrastructure 704—such as a bus—, which forwards data such as graphics, text, and information, from the communication infrastructure 704 or from a frame buffer (not shown) to other components of the computer system 700. The input/output display interface 702 may be, for example, a keyboard, touch screen, joystick, trackball, mouse, monitor, speaker, printer, Google Glass® unit, web camera, any other computer peripheral device, or any combination thereof, capable of entering and/or viewing data.

Computer system 700 includes one or more processors 706, which may be a special purpose or a general-purpose digital signal processor configured to process certain information. Computer system 700 also includes a main memory 708, for example random access memory (RAM), read-only memory (ROM), mass storage device, or any combination thereof. Computer system 700 may also include a secondary memory 710 such as a hard disk unit 712, a removable storage unit 714, or any combination thereof. Computer system 700 may also include a communication interface 716, for example, a modem, a network interface (such as an Ethernet card or Ethernet cable), a communication port, a PCMCIA slot and card, wired or wireless systems (such as Wi-Fi, Bluetooth, Infrared), local area networks, wide area networks, intranets, etc.

It is contemplated that the main memory 708, secondary memory 710, communication interface 716, or a combination thereof, function as a computer usable storage medium, otherwise referred to as a computer readable storage medium, to store and/or access computer software including computer instructions. For example, computer programs or other instructions may be loaded into the computer system 300 such as through a removable storage device, for example, ZIP disks, magnetic tape, portable flash drive, optical disk such as a CD or DVD or Blu-ray, Micro-Electro-Mechanical Systems (MEMS), nanotechnological apparatus. Specifically, computer software including computer instructions may be transferred from the removable storage unit 714 or hard disc unit 712 to the secondary memory 710 or through the communication infrastructure 704 to the main memory 708 of the computer system 700.

Communication interface 716 allows software, instructions and data to be transferred between the computer system 700 and external devices or external networks. Software, instructions, and/or data transferred by the communication interface 716 are typically in the form of signals that may be electronic, electromagnetic, optical or other signals capable of being sent and received by the communication interface 716. Signals may be sent and received using wire or cable, fiber optics, a phone line, a cellular phone link, a Radio Frequency (RF) link, wireless link, or other communication channels.

Computer programs, when executed, enable the computer system 700, particularly the processor 706, to implement the methods of the invention according to computer software including instructions.

The computer system 700 described herein may perform any one of, or any combination of, the steps of any of the methods presented herein. It is also contemplated that the methods according to the invention may be performed automatically, or may be invoked by some form of manual intervention.

The computer system 700 of FIG. 7 is provided only for purposes of illustration, such that the invention is not limited to this specific embodiment. It is appreciated that a person skilled in the relevant art knows how to program and implement the invention using any computer system.

The computer system 700 may be a handheld device and include any small-sized computer device including, for example, a personal digital assistant (PDA), smart hand-held computing device, cellular telephone, or a laptop or netbook computer, hand held console or MP3 player, tablet, or similar hand held computer device, such as an iPad®, iPad Touch® or iPhone®.

The described embodiments are to be considered in all respects only as illustrative and not restrictive, and the scope of the invention is not limited to the foregoing description. Those of skill in the art may recognize changes, substitutions, adaptations and other modifications that may nonetheless come within the scope of the invention and range of the invention.

1. A computer system method for identifying and evaluating patient variables, the computer system including a processor configured to execute the steps comprising:
accessing a data warehouse;
retrieving by the processor from a data warehouse data relating to one or more patients of a patient population to obtain a database of patient records, each patient record corresponding to a patient of the patient population;
sorting by the processor the one or more patient records according to a diagnosis to obtain a set of diagnosed patient records;
obtaining by the processor from the data warehouse one or more patient variables;
joining by the processor the one or more patient variables to each diagnosed patient record of the set, the one or more patient variables comprising:
an admission date and a discharge date of each hospitalization, one or more weight measurements,
one or more laboratory results,
one or more vital signs;
one or more drug treatments classes;
providing by the processor a patient profile for each diagnosed patient record of the set, the patient profile based on the one or more patient variables;
identifying by the processor the one or more patient profiles that match a failure mode;
assigning by the processor the failure mode to each patient profile; and
supplying by the processor a solution for the failure mode.

2. The computer system method according to claim 1, wherein the diagnosis is classified according to the International Classification of Diseases.

3. The computer system method according to claim 1, wherein the diagnosis is congestive heart failure.

4. The computer system method according to claim 1, wherein the one or more weight measurements are a standard weight value, an admission weight value, dry weight value, a discharge weight value, and a re-admission weight.

5. The computer system method according to claim 1, wherein the linking step further comprises the step of calculaing a weight trajectory from the one ore more weight measurements.

6. The computer system method according to claim 1, wherein the one or more laboratory results relate to serum digoxin, glomerular filtration and brain natriuretic peptide.

7. The computer system method according to claim 1, wherein the one or more vital signs comprise pulse, blood pressure, weight, and height.

8. The computer system method according to claim 7, wherein body mass index is calculated from weight and height.

9. The computer system method according to claim 1, wherein the one or more drug treatments classes comprises digoxin, beta-blockers, spironolactone, angiotensin converting enzyme inhibitors, and angiotensin receptor blocking agents.

10. The computer system method according to claim 1, wherein the failure mode is one or more comprising: inadequate prevention, volume overload, inadequate initial treatment, inadequate diuresis, and failed discharge plan.

11. The computer system method according to claim 1, wherein the solution is one or more comprising: a monitored prevention program using heart failure drugs, diuretic self-titration, a changed protocol on hospital admission, individualized discharge criterion, and supervised post-hospital care.
